(19) United States
(12) Patent Application Publication
(10) Pub. No.: US 2024/0199064 A1
(43) Pub. Date: Jun. 20, 2024

(54) MANAGING VEHICLE FUNCTIONS BASED ON COMBINATION OF GEOGRAPHICAL LOCATION, NETWORK CONDITIONS, AND PRIORITIES

(71) Applicant: Volkswagon Group of America, Inc., Herndon, VA (US)

(72) Inventor: Hannes Steinhaeuser, Herndon, VA (US)

(21) Appl. No.: 18/085,468

(22) Filed: Dec. 20, 2022

(51) Int. Cl. B60W 60/00; H04L 43/08

(52) U.S. Cl. CPC B60W 60/001; H04L 43/08; B60W 2555/60; B60W 2556/45; H04L 67/12

(57) ABSTRACT

A method, apparatus and system are provided to manage vehicle functions. The vehicle functions are managed by determining one or more of a geographical location of a vehicle and network conditions for the vehicle. A set of vehicle functions to be assisted by a computing device external to the vehicle are identified based on one or more of the geographical location and the network conditions. A set of sensor data for the set of vehicle functions is transmitted to the computing device.

### TECHNICAL FIELD

Aspects of the present disclosure relate to vehicle functionality, and more particularly, to managing vehicle functions with assistance from an external computing device based on combination of network conditions, geographical locations, and priorities.

### BACKGROUND

Vehicles, such as motorcycles, cars, trucks, vans, planes, drones, boats, submarines, semi-autonomous vehicles, autonomous vehicles, etc., may perform various functions during the operation of the vehicles. For example, a vehicle (e.g., a car) may detect lanes within a street or a freeway. In another example, the vehicle may detect objects (e.g., pedestrians, signs, cones, etc.) in a geographical location where the vehicle is located. In a further example, the vehicle may adjust the cabin temperature in the cabin of the vehicle. Vehicle functions may have certain requirements (e.g., may use/require a certain amount of processing power, may use certain hardware, software, components, systems, etc.). If the required hardware, software, components, systems, etc., are not in the vehicle, the vehicle may not be able to perform those certain vehicle functions. In addition, it may be preferable for a vehicle to save processing power or energy usage for performing other vehicle functions. It may also be useful to have better and/or more efficient results when performing the vehicle function.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system architecture, in accordance with one or more embodiments of the present disclosure.

FIG. 2 is a diagram that illustrates an example geographical location where a vehicle may be located, in accordance with one or more embodiments of the present disclosure.

FIG. 3 is a diagram illustrating an example vehicle function module, in accordance with one or more embodiments of the present disclosure.

FIG. 4A is a flow diagram of a process for performing vehicle functions, in accordance with one or more embodiments of the present disclosure.

FIG. 4B is a flow diagram of a process for identifying vehicle functions, in accordance with one or more embodiments of the present disclosure.

FIG. 5 is a diagram illustrating an example server function module, in accordance with one or more embodiments of the present disclosure.

FIG. 6 is a flow diagram of a process for performing vehicle functions, in accordance with one or more embodiments of the present disclosure.

FIG. 7 is a block diagram illustrating an example vehicle, in accordance with one or more embodiments of the present disclosure.

FIG. 8 is a block diagram of an example computing device that may perform one or more of the operations described herein, in accordance with some embodiments of the present disclosure.

### DETAILED DESCRIPTION

As discussed above, a vehicle may perform various functions while the vehicle is operating. For example, the vehicle may assist the driver in driving the vehicle (e.g., an assisted driving function that may help steer, acceleration, or decelerate the vehicle). In another example, the vehicle may assist the driver in parking the vehicle (e.g., an assisted parking function). In a further example, the vehicle may perform image segmentation (e.g., partitioning of an image into multiple regions or sets of pixels representing objects). The functions are performed by the vehicle (while in operation) may be referred to as vehicle functions, vehicle operations, vehicle activities, etc.

Performing certain vehicle functions may require certain hardware, software, components, systems, etc., to be installed in or to be part of the vehicle. If the required hardware, software, components, systems, etc., are not in the vehicle, the vehicle may not be able to perform those certain vehicle functions. In addition, it may be preferable for a vehicle to save processing power or energy usage for performing other vehicle functions. For example, performing certain vehicle functions may use more than a desired amount of processing power available to the vehicle, which may prevent the vehicle from performing other vehicle functions. Furthermore, it may be useful to have better and/or more efficient results when performing the vehicle function. For example, although a vehicle may also be able to detect objects in an image, it may be useful to have more accurate, quicker, or more efficient object detection.

The examples, implementations, and/or embodiments described herein may be used to assist a vehicle in performing vehicle functions and/or to perform vehicle functions for a vehicle. For example, the vehicle may transmit sensor data to an external computing device and the external computing device may perform the vehicle function on behalf of the vehicle (e.g., may identify objects in an image, may determine a path around obstacles in a street, etc.). Using an external device to perform or assist in performing the vehicle functions may be referred to as offloading vehicle functions to the external devices. Offloading the vehicle functions to one or more external computing devices may allow the vehicle to perform vehicle functions more quickly, efficiently, accurately, etc. In addition, offloading the vehicle functions to one or more external computing device may allow the vehicle to perform vehicle functions that the vehicle would otherwise not be able to perform, due to lack of hardware, software, etc.

Although the present disclosure may refer to certain types of vehicle functions, the examples, implementations, aspects, and/or embodiments described herein may be used with other types of functions, operations, actions, etc., that may generally be performed by a vehicle, with or without input from an operator (e.g., a driver). In addition, the geographical locations, types of geographical locations, and sensor data described herein are merely examples. Other geographical locations, types of geographical locations, and sensor data may be used in other embodiments.

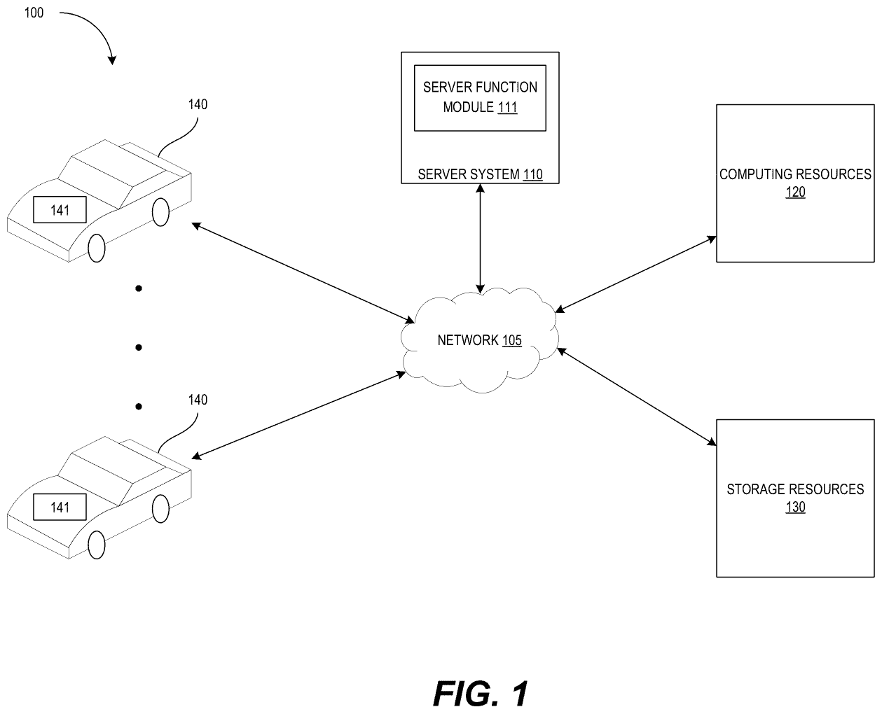

FIG. 1 is a block diagram that illustrates an example system architecture 100, in accordance with some embodiments of the present disclosure. The system architecture 100 includes a server system 110, computing resources 120, storage resources 130, and vehicles 140. Network 105 may interconnect the vehicles 140, the server system 110, the computing resources 120, and/or the storage resources 130. The network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g., cell towers), etc. The network 105 may carry communications (e.g., data, message, packets, frames, etc.) between the vehicles 140, the server system 110, the computing resources 120 and/or the storage resources 130.

The vehicles 140 may be commercial vehicles (e.g., vehicles that are available for purchase or general use), test vehicles, semi-autonomous vehicles, and/or autonomous vehicles (AVs). In one embodiment, the vehicles 140 may be a fleet of vehicles that are used to collect, capture, gather, compile, etc., sensor data and/or other data that may be used to develop, improve, refine, or enhance machine learning models. Machine learning models may be models that may be used to manage and/or control the operation of a vehicle. Each of the vehicles 140 may include various sensors that may generate data (e.g., sensor data) as the respective vehicle operates (e.g., drives, moves around, or is otherwise on). Examples of sensors may include, but are not limited to, tire pressure sensors, steering sensors (e.g., to determine the positions/angles of one or more wheels), a compass, temperature sensors, a global positioning system (GPS) receiver/sensor, a light detection and ranging (LIDAR) device/sensor, an ultrasonic device/sensor, a camera (e.g., a video camera), a radar device/sensor, etc. The sensors of the vehicles 140 may generate sensor data such as video data, image data, GPS data, LIDAR data, time series data, etc. Each of the vehicles 140 by way of its sensors may generate gigabytes (e.g., tens, hundreds, thousands, etc., of gigabytes) of data per hour of operation. Each vehicle 140 may include a vehicle function module 141 (e.g., firmware, software, hardware, or a combination thereof). The vehicle function module 141 is discussed in more detail below.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the server system 110, one or more of the computing resources 120 and the storage resources 130 may be part of the server system 110 in other embodiments. For example, the server system 110 may include both the computing resources 120 and the storage resources 130.

In one embodiment, the server system 110 may be a collection of one or more computing devices (e.g., one or more server computers), hardware, software, firmware, a cloud computing system/platform, and/or other devices/systems. The server system 110 may perform various functions, operations, actions, etc., for the vehicles 140. In particular, the server system 110 may assist vehicles 140 in performing various vehicle functions, and/or may perform the vehicle functions for the vehicles 140 (e.g., on behalf of the vehicles 140).

In one embodiment, data (e.g., sensor data such as CAN data, images, videos, GPS data, LIDAR data, speed, acceleration, etc.) may be received, collected, ingested, etc., from vehicles 140 (e.g., a fleet of vehicles). The server system 110 may use the data (e.g., sensor data) received from the vehicles 140 to assist the vehicles 140 in performing various vehicle functions (e.g., climate control functions, assisted driving functions, parking assistance functions, pedestrian detection functions, etc.). For example, the server function module 111 may receive sensor data from the vehicles 140 (e.g., video data) and perform calculations or functions (e.g., detecting objects using machine learning models) based on the sensor data, as discussed in more detail below.

In one embodiment, the server system 110 may manage the allocation, deallocation, and/or use of computing resources 120 (e.g., computing clusters, server computers, VMs, containers, etc.). The computing resources 120 may be used for data transformation, feature extraction, execution of machine learning models, etc. The computing resources 120 may use various cloud service platforms (e.g., cloud computing resources). The server system 110 may also manage the allocation and/or use of storage resources 130. The storage resources 130 may store training data, machine learning models, and/or any other data used to assist the vehicles 140 in performing various vehicle functions.

In some embodiments, a vehicle 140 may be unable to perform certain vehicle functions within the vehicle 140. For example, the vehicle 140 may lack of enough processing power to performing computations, calculations, etc., used for a vehicle function. In another example, the vehicle 140 may lack the machine learning models or software used to perform a vehicle function. In addition, it may also be useful to assist the vehicle 140 in performing certain vehicle functions. For example, performing computations, calculations, etc., used in various vehicle functions on an external computing device may help the vehicle 140 save processing power and use that processing power for other vehicle functions. In another example, performing computations/calculations on an external computing device may allow the vehicle 140 to use less energy/power. In a further example, performing computations, calculations, etc., used in various vehicle functions on an external computing device may allow for better and/or more efficient results when performing the vehicle function. For example, because the external computing device may have more processing power and/or may have better machine learning models than what is available on the vehicle, the external computing device may be able to identify objects in an image more quickly, efficiently, and/or accurately.

In addition, when the server system 110 (e.g., an external computing device) is able to assist the vehicle 140 with performing vehicle functions (e.g., when vehicle functions can be offloaded to the server system 110), the bandwidth between the external computing device may affect that amount of sensor data that the vehicle 140 can transmit to the server system 110. The amount of sensor data that the vehicle 140 can transmit to the server system 110 may affect the type or number of vehicle functions that may be offloaded to the server system 110.

The vehicle function module 141 may identify a set of vehicle functions that should be performed based on one or more of network conditions and the geographical location where the vehicle is located. The set of vehicle functions may also be identified based on priorities for the vehicle functions. The vehicle function module 141 may transmit sensor data used for the vehicle functions to server system 110 (e.g., to a computing device that is external to the vehicle 140). The server system 110 (e.g., the server function module 111) may assist the vehicle 140 in performing the vehicle functions (e.g., may perform computations based on the sensor data) and may transmit instructions to the vehicle function module 141. The vehicle function module 141 may perform the vehicle functions based on the instructions received from the external computing device.

In one embodiment, the vehicle function module 141 and/or the server function module 111 may allow the vehicle 140 to perform vehicle functions that were previously unperformable by the vehicle (e.g., due to a lack of hardware or software). For example, the vehicle operations that the vehicle could not perform (due to lack of hardware/software) may be performed by the server system 110. The vehicle function module 141 and/or the server function module 111 may also allow the vehicle 140 to reduce the resources (e.g., energy, power, processing power, etc.) used by the vehicle 140 when performing vehicle functions. For example, offloading some vehicle functions to the server system 110 may reduce the amount of processing resources used by the vehicle, which may allow the vehicle to perform additional vehicle functions using the saved processing resources.

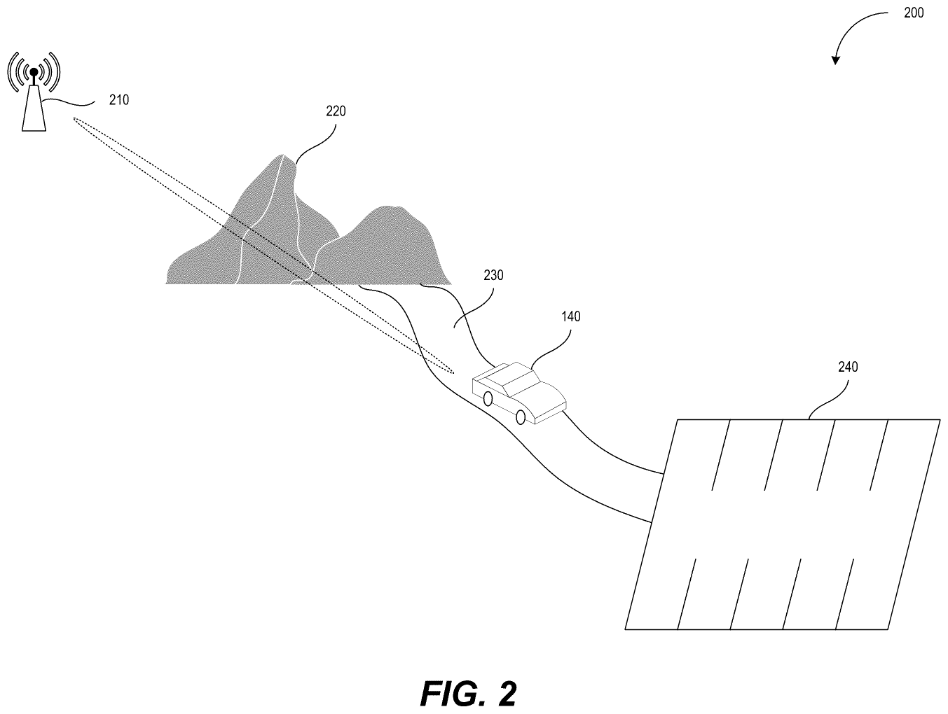

FIG. 2 is a diagram that illustrates an example geographical location 200 where a vehicle 140 may be located, in accordance with one or more embodiments of the present disclosure. The vehicle 140 may be travelling through and/or located in the geographical location 200. For example, the vehicle 140 may be physically located in the geographical location 200. As illustrated in FIG. 2, the geographical location 200 includes other geographical locations. For example, geographical location 200 includes geographical location 220 (e.g., a mountainous area), geographical location 230 (e.g., a highway), and geographical location 240 (e.g., a parking lot). As the vehicle travels through geographical location 200, the vehicle 140 may move between geographical locations 220, 230, and 240.

The geographical location also includes a cell tower 210 that may be in communication with the vehicle 140. For example, the vehicle 140 may transmit and/or receive data via the cell tower 210. When the vehicle is at geographical location 230 or at geographical location 240, the radio frequency (RF) signals (e.g., the dotted oval) may be obstructed (e.g., fully or partially blocked, obscured, etc.) by the mountains/hills in the geographical location 220. This may affect the network conditions that are experienced by the vehicle 140. For example, the data bandwidth (e.g., network bandwidth, data throughput, etc.) may be reduced due to the mountains/hills in the geographical location 220. This may reduce the amount of data that can be communicated between an external computing device (e.g., server system 110 illustrated in FIG. 1) and the vehicle 140 (e.g., may reduce the amount of sensor data that can be transmitted by the vehicle 140 to an external computing device via the cell tower 210).

As discussed above, it may be useful for the external computing device to assist the vehicle 140 in performing various vehicle functions. The vehicle 140 may transmit sensor data (e.g., video, images, GPS data, LIDAR data, etc.) or other data to a server system and the server system may assist the vehicle 140 in performing vehicle function and/or may perform the vehicle function for the vehicle 140. The vehicle 140 may determine appropriate vehicle functions based on the geographical area. For example, the vehicle functions that may be appropriate in geographical location 230 (e.g., a freeway) may be different than vehicle functions that are appropriate in geographical location 240 (e.g., a parking lot).

The vehicle 140 may also determine whether there is enough bandwidth for the vehicle functions. For example, the vehicle 140 may determine whether there is enough bandwidth to transmit the sensor data used by the vehicle functions. If there is not enough bandwidth for all the vehicle functions, the vehicle 140 may select a subset of the vehicle functions based on the amount of sensor data used for the vehicle functions, the data bandwidth, and priorities associated with the vehicle functions, as discussed in more detail below.

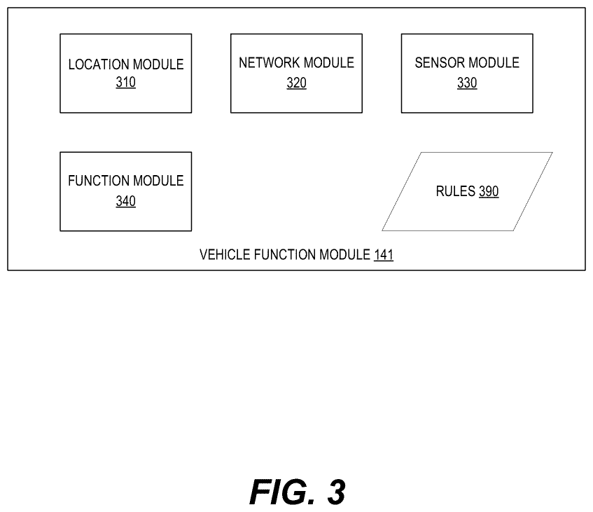

FIG. 3 is a block diagram that illustrates an example vehicle function module 141, in accordance with one or more embodiments of the present disclosure. The vehicle function module 141 includes a location module 310, a network module 320, a sensor module 330, a function module 340, and rules 390. Some or all of the modules, components, systems, engines, etc., illustrated in FIG. 3 may be implemented in software, hardware, firmware, or a combination thereof. The vehicle function module 141 may be part of a vehicle 140 (e.g., as illustrated in FIGS. 1, 2, and 7).

In one embodiment, the location module 310 may determine the location of the vehicle 140. For example, the location module 310 may interact/communicate with one or more sensors (e.g., a GPS sensor) to determine the geographical location of the vehicle 140. The GPS sensor may provide GPS coordinates or some other location information (e.g., a longitude and a latitude) that may indicate the location of the vehicle 140.

In one embodiment, the location module 310 may use map data (e.g., data that may indicate a map of a geographical location where the vehicle 140 is located) to determine a type of geographical location where the vehicle 140 is located. For example, a geographical location may include parking lots, surface streets, side streets, alleys, highways, freeways, expressways, lane, etc. The location module 310 may use GPS coordinates and the map data to determine where the vehicle 140 is located and the type of the geographical location. For example, the location module 310 may use the GPS coordinates and map data to determine that the vehicle 140 is in a parking lot, on a freeway, etc. The type of the geographical location may also be referred to as a geographical scenario.

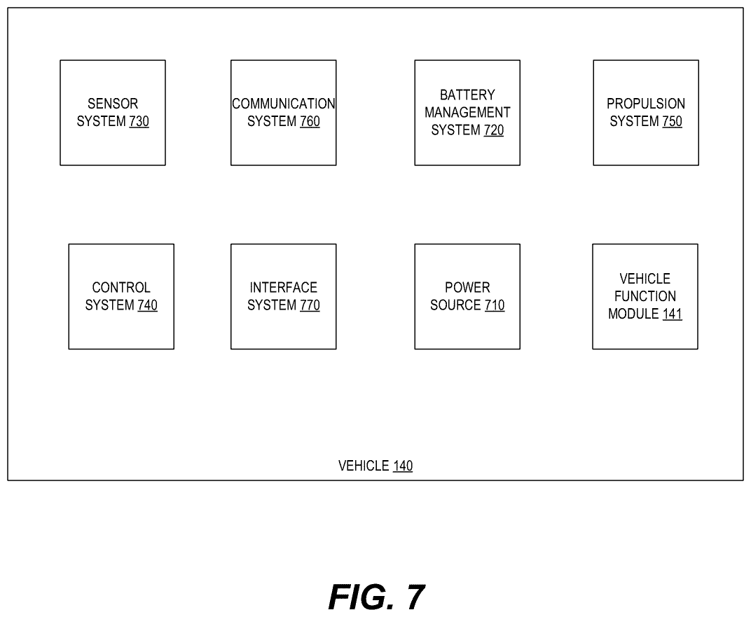

In one embodiment, the network module 320 may determine network conditions for the vehicle 140. The network conditions may indicate the condition, state, quality, status, etc., of communications (e.g., transmission and/or receipt of data) between the vehicle (e.g., communication system 760 illustrated in FIG. 7) and another device, such as a server computer (e.g., a computing device or server in the server system 110 illustrated in FIG. 1). Various parameters, metrics, criteria, etc., may be used to measure and/or represent network conditions. For example, one or more of the latency of data (e.g., amount of time to transmit and/or receive data), the throughput/bandwidth (e.g., amount of data transmitted/received in a period of time), jitter (e.g., changes in the latency), the amount of data loss, the amount/percentage of errors in data, the amount of noise/interference (e.g., noise from other wireless communication devices), etc., may be used to determine and/or measure network conditions. The network module 320 may determine or measure the various parameters, metrics, criteria, etc., to determine the network conditions for a vehicle 140. The network conditions determine for the vehicle 140 may be for a particular location.

In one embodiment, the network conditions (determined by the network module) may be a combination of the various parameters, metrics, criteria, etc. One or more parameters, metrics, criteria, may be added, multiplied, weighted, or otherwise combined to generate a single metric that may represent the network conditions. For example, the data bandwidth, latency, and amount of noise/interference may be combined to generate a number representing the current network conditions. In another example, the data bandwidth and the latency may be combined to generate an alphanumeric representation of the current network conditions (e.g., excellent, good, average, below average, poor, etc.). Other embodiments may represent network conditions in any appropriate manner.

In one embodiment, the sensor module 330 may communicate and/or interact with a sensor system (e.g., sensor system 730 illustrated in FIG. 7) of the vehicle 140. For example, the sensor module 330 may obtain and/or receive sensor data that is generated by one or more sensors of the vehicle 140. For example, the sensor module 330 may access sensor data that is captured, recorded, detected, obtained, etc., by one or more sensors of the sensor system (e.g., the sensors may store the sensor data in a memory that may be accessed by the sensor module 330). In another example, the sensors may provide the sensor data to the sensor module 330 (e.g., the sensors may transmit the sensor data to the sensor module via a communication bus).

As discussed above, vehicle functions may be operations, actions, functions, processes, procedures, etc., that may be performed by the vehicle 140 as the vehicle 140 operates. For example, a vehicle function may be a function/operation that controls the climate of the vehicle 140, performs object detection, performs driving assistance functions, performs parking assistance functions, etc. In one embodiment, the function module 340 may identify a set of vehicle functions that may be assisted by a computing device external to the vehicle. For example, the function module 340 may identify one or more vehicle functions where a computing device (e.g., a server computer, a computing device/resource in a cloud computing system/platform) may assist the vehicle 140 in performing the one or more vehicle functions. The computing device that is external to the vehicle 140 (e.g., a computing device or system that is not located within the vehicle) may assist, help, cooperate, collaborate, or facilitate the vehicle operation (e.g., the performance of the vehicle operation) in various ways. The external computing device may perform computations, calculations, estimations, predictions, etc., that may be used for the vehicle operation. For example, the external computing device may analyze sensor data (e.g., images, video, radar data, LIDAR data, etc.) to determine a path on a highway that avoids other vehicles and obstacles on the highway. In another example, the external computing device may analyze sensor data (e.g., images, video, etc.) to detect pedestrians, bicyclists, or other objects that may be in the vicinity of the vehicle 140. In a further example, the external computing device may analyze sensor data to identify lanes in a road. The external computing device (or computing system) may use various other systems, modules, hardware, software, services, and/or other mechanisms to assist the vehicle 140 in performing a vehicle operation, as discussed in more detail below.

In one embodiment, the set of vehicle functions (to be assisted by the external computing device) that are identified by the function module 340 may be a subset of a plurality of vehicle functions that the vehicle 140 is capable of performing, executing, carrying out, etc. For example, a vehicle 140 may be capable of performing tens, hundreds, or any other appropriate number of vehicle functions. The set of vehicle functions that are identified by the function module may be a subset of all the possible vehicle functions that the vehicle 140 is capable of performing.

In one embodiment, the function module 340 may identify a set of vehicle functions (to be assisted by the external computing device) based on an amount of data that can be transmitted to the external computing device. As discussed above, the network module 320 may determine an amount of data that can be transmitted to the external computing device with current network conditions. For example, the network module 320 may determine the data bandwidth/throughput (e.g., 1 MB/sec, 5 MB/sec, 32 MB/sec, etc.) given current network conditions. The network module 320 may communicate the data bandwidth/throughput to the function module 340. The function module 340 may identify the set of vehicle functions from a plurality of vehicle functions based on the data bandwidth/throughput, as discussed in more detail below.

In one embodiment, the function module 340 may identify the set of vehicle functions (to be assisted by the external computing device) based on the geographical location of the vehicle 140. As discussed above, the location module 310 may determine the geographical location of the vehicle 140 (e.g., GPS coordinates of the vehicle 140). The location module 310 may also determine the type of the geographical location of the vehicle 140 (e.g., highway, parking lot, surface street, etc.). The function module 340 may identify the set of vehicle functions (from a plurality of vehicle functions) based on the geographical location and/or type of geographical location. For example, if the vehicle 140 is in a parking lot, the function module 340 may identify an assisted parking function (e.g., an autonomous or partially autonomous parking function) as one of the vehicle functions that should be assisted by the external computing device. In another example, if the vehicle in on a freeway/highway, the function module 340 may identify an assisted driving function (e.g., an autonomous or partially autonomous driving function) as one of the vehicle functions that should be assisted by the external computing device.

In one embodiment, the set of vehicle functions that are identified by the function module 340 may be performable/appropriate for the geographical location and/or type of geographical location. For example, the function module 340 may not identify an assisted parking function (e.g., a vehicle function) as appropriate/performable when the vehicle 140 is located on a highway/freeway (e.g., because there is generally no parking on a highway/freeway). In another example, the function module 340 may identify a climate control function (e.g., cabin temperature control) as appropriate or performable in all geographical locations or types of locations.

In one embodiment, the rules 390 may indicate which vehicle functions are performable in which geographical regions and/or types of geographical regions. For example, the rules 390 may include one or more tables, lists, entries, or some other appropriate data structure that associates geographic locations (or types of geographical locations) with vehicle actions that are appropriate/performable in those geographical locations.

In one embodiment, each of the plurality of vehicle functions may be associated with, assigned, etc., a priority. A priority for a vehicle function may indicate an importance, preference, rank, etc., for vehicle function. For example, a priority may be a number and a lower number may indicate a higher priority/importance and a higher number may indicate a lower priority/importance. The priorities of vehicle functions may be represented using various formats, such as alphanumeric strings, numbers, etc. The priorities for the vehicle functions may be stored in the rules 390. For example, the rules 390 may include various tables, lists, and/or other appropriate data structures/formats for storing the priorities for the vehicle functions.

In one embodiment, vehicle functions may have different priorities for different geographical locations and/or for different types of geographical locations. For example, an assisted parking function may have a low (or the lowest) priority when the vehicle 140 is located on the freeway, but may have a high (or highest) priority when the vehicle 140 is located in a parking lot. In another example, a pedestrian detection function (e.g., a system that detects pedestrians in a road) may have a lower priority when the vehicle 140 is located on a freeway, but may have a higher priority when the vehicle 140 is located on city streets or roads.

In one embodiment, the priorities for the vehicle functions may be received from another computing device (e.g., from a server or computing device in server system 110 illustrated in FIG. 1). For example, the computing device may transmit priorities for the vehicle functions to the vehicle 140 and the vehicle 140 may store those priorities in the rules 390. The computing device may also update priorities for vehicle functions. For example, the computing device may change the priority (e.g., increase the priority) for a climate control function.

In one embodiment, the function module 340 may identify the set of vehicle functions (to be assisted by the external computing device) based on a set of priorities (e.g., one or more priorities) associated with the set of vehicle functions. For example, if there are vehicle functions with a range of priorities, the function module 340 may identify or select vehicle applications that have higher priorities as opposed to vehicle functions with lower priorities.

In some embodiments, the function module 340 may identify the set of vehicle functions (to be assisted by the external computing device) based on a combination of the network conditions, geographical location, priorities, and the rules 390. For example, the function module 340 may identify vehicle functions that are appropriate/performable for a geographical location (or type of geographical location). The function module 340 may then determine the data bandwidth for the vehicle (e.g., the amount of data that can be transmitted/received during a period of time). Based on the vehicle functions (that are appropriate/performable in the geographical location) and the data bandwidth, the function module 340 may identify vehicle functions that should be performed with assistance from an external computing device. For example, the function module 340 may determine the amount of sensor data that is used for a set of vehicle functions that are appropriate for an area. The function module 340 may identify one or more of the set of vehicle functions (that are appropriate for the geographical area) based on whether there is enough data bandwidth for the sensor data used by those vehicle functions. Examples of the rules 390 are illustrated and discussed below in Tables 1-3.

TABLE 1

| | Geographical | | | Amount of |
|---|---|---|---|---|
| ID | Location | Priority | Function | Sensor Data |
| A | Highway | 1 | Lane detection | 2500 kB |
| B | All | 1 | Image | 2160 kB |
| | | | segmentation | |
| C | All | 2 | Climate control | 25 kB |
| D | Street/City | 2 | Pedestrian | 500 kB |
| | | | detection | |
| E | Parking lot | 3 | Park assist | 3600 kB |

Table 1 above illustrates example of vehicle functions, priorities, and geographical locations that maybe be stored in the rules 390. Each row of Table 1 represents a vehicle function. The first column of Table 1 indicates an identifier for a vehicle function. The second column of Table 1 indicates the geographical location where the vehicle function may be performable/appropriate. The third column of Table 1 indicates a priority associated with the vehicle function. The fourth column of Table 1 describes the vehicle function. The fifth column of Table 1 indicates the amount of sensor data used for the vehicle function.

TABLE 2

| | Available | | | Amount of |
|---|---|---|---|---|
| Link quality | bandwidth | | Vehicle Functions | sensor data |
| Excellent | 20000 | kB | A, B, C, D, E | 8785 kB |
| Good | 10000 | kB | A, B, C, D, E | 8785 kB |
| Average | 5000 | kB | A, B, C | 4685 kB |
| Below | 2250 | kB | B | 2160 kB |
| Average | | | | |
| Poor | 500 | kB | B | 2160 kB |

Table 2 above illustrates example rules for performing vehicle functions based on network conditions. The geographical location may not be a factor when identifying/selecting vehicle functions based on Table 2. The first column of Table 2 indicates a network condition (e.g., excellent, good, etc.). The second column of Table 2 indicates the amount of data bandwidth for a particular network condition. The third column of Table 2 indicates identifiers for the vehicle functions that can be performed for a particular network condition. The identifiers are described in Table 1 above. The fourth column of Table 2 indicates the amount of sensor data used by the vehicle functions.

TABLE 3

| | Geographical | Available | | Vehicle | Amount of |
|---|---|---|---|---|---|
| Link quality | Location | bandwidth | | Functions | sensor data |
| Excellent | City | 20000 | kB | B, C, D | 2685 kB |
| Good | City | 10000 | kB | B, C, D | 2685 kB |
| Average | City | 5000 | kB | B, C, D | 2685 kB |
| Below | City | 2250 | kB | B | 2160 kB |
| Average | | | | | |
| Poor | City | 500 | kB | B | 2160 kB |
| Excellent | Highway | 20000 | kB | A, B, C | 4685 kB |
| Good | Highway | 10000 | kB | A, B, C | 4685 kB |
| Average | Highway | 5000 | kB | A, B, C | 4685 kB |
| Below | Highway | 2250 | kB | B, C | 2185 kB |
| Average | | | | | |
| Poor | Highway | 500 | kB | B | 2160 kB |
| Excellent | Parking lot | 20000 | kB | B, C, E | 5785 kB |
| Good | Parking lot | 10000 | kB | B, C, E | 5785 kB |
| Average | Parking lot | 5000 | kB | B, C | 2185 kB |
| Below | Parking lot | 2250 | kB | B, C | 2185 kB |
| Average | | | | | |
| Poor | Parking lot | 500 | kB | B | 2160 kB |

Table 3 above illustrates example rules for performing vehicle functions based on network conditions and geographical locations. The first column of Table 3 indicates a network condition (e.g., excellent, good, etc.). The second column of Table 3 indicates a geographical location where the vehicle functions may be performed. The third column of Table 3 indicates the amount of data bandwidth for a particular network condition. The fourth column of Table 3 indicates identifiers for the vehicle functions that can be performed for a particular network condition. The identifiers are described in Table 1 above. The fifth column of Table 3 indicates the amount of sensor data used by the vehicle functions.

In one embodiment, the function module 340 may receive update data for the set of rules 390 (e.g., conditions, parameters, criteria, etc.). For example, the external computing devices (or some other computing device) may transmit the update data to the vehicle 140. The update data may be data that includes or indicates modifications, changes, updates, etc., to the set of rules 390 that are used to identify vehicle functions based on network conditions and/or geographical location. For example, the update data may include/indicate a change of priority for vehicle function, a new geographical location where a vehicle function may be performable/appropriate, etc. In another example, the update data may include/indicate deletions to the set of rules 390 (e.g., the removal or deletion of one or more rules 390). In a further example, the update data may include/indicate new rules (e.g., an addition or one or more rules to the set of rules). The function module 340 may update the set of rules 390 (e.g., may update Tables 1-3) based on the update data. For example, the function module 340 may add a rule 390, delete a rule 390, and/or update a rule 390 based on the update data.

In one embodiment, the function module 340 may transmit a set of sensor data to the external computing device, based on the set of vehicle functions that are identified by the function module 340. The function module 340 may determine, identify, select, etc., one or more sensors that are used by the set of vehicle functions. For example, if an assisted driving function is identified, the function module 340 may determine which sensors (e.g., cameras, radar sensors, LIDAR sensors, etc.) are used by the assisted driving function. The function module 340 may select, identify, etc., the sensor data from those sensors that are used by the selected/identified set of vehicle functions. The function module 340 may access the sensor data (generated by the sensor that are used by the selected/identified set of vehicle functions) and may transmit that sensor data to the external computing device. The selected/identified sensor data may be a subset of all sensor data that is generated by the sensors the vehicle 140.

In one embodiment, the function module 340 may also indicate (to the external computing device) which vehicle functions the external computing device should assist with or perform. For example, the function module 340 may transmit a message or some other data indicating which vehicle functions the external computing device should assist with.

In one embodiment, the function module 340 may receive additional data in response to transmitting the set of sensor data to the external computing device. The additional data may be received from the external computing device (where the sensor data was transmitted to by the function module 340) or may be received from another computing device that is external to the vehicle 140. The function module 340 and/or other systems/components of the vehicle 140 may perform one or more vehicle functions based on the additional data. For example, the function module 340 may operate in conjunction with other systems (e.g., control system 740 and/or propulsion system 750 illustrated in FIG. 7) to perform various vehicle functions based on the additional data.

In one embodiment, the additional data may include instructions for performing one or more vehicle functions. For example, the additional data may include temperature settings, fan speed settings, seat warmer settings, etc., for a climate control function (e.g., a vehicle function). The function module 340 may transmit the instructions to a climate control system of the vehicle 140 to adjust the climate in the vehicle based on the instructions (e.g., to set the cabin temperature), or may instruct the climate control system to change the temperature based on the instructions. In another example, the additional data may include a speed and a path for the vehicle 140. The function module 340 may coordinate or operate in conjunction with the control and propulsion systems of the vehicle 140 (control system 740 and/or propulsion system 750 illustrated in FIG. 7) to adjust the speed and/or path of the vehicle 140, based on the instructions. For example, the function module 340 may provide the instructions to the control and propulsion systems of the vehicle 140, and the control and propulsion systems of the vehicle 140 may adjust the speed and/or path of the vehicle 140.

In one embodiment, the additional data may include the results of one or more vehicle functions. For example, the external computing device may perform object detection (e.g., a vehicle function) based on images (e.g., sensor data) receive from the vehicle. The additional data received from the external computing device may include a list of objects that were detected in the images.

In one embodiment, the vehicle function module 141 may adjust the collection of additional sensor data (e.g., future sensor data, further sensor data, etc.) and/or may cause the collection of additional sensor data to be adjusted, based on one or more of the geographical location and network conditions. For example, if the data throughput/bandwidth (e.g., a network condition) is below a threshold, the vehicle function module 141 may determine that the amount of sensor data that is collected, recorded, obtained, etc., by one or more sensors should be reduced. The vehicle function module 141 (e.g., the sensor module 330) may transmit message or instruction to the one or more sensors (or to a sensor system) instructing the one or more sensors to reduce the amount of sensor data that is collected. For example, if the sensor is a camera, the vehicle function module 141 may transmit a message instructing the camera to decrease the framerate and/or resolution of the video/images that are captured by the camera.

As discussed above, the vehicle 140 may be unable to perform certain vehicle functions within the vehicle 140. For example, the vehicle 140 may lack of processing power, hardware, software, etc., for performing certain vehicle functions. It may also be useful to provide the vehicle 140 with assistance in performing certain vehicle functions. For example, performing computations, calculations, etc., used in various vehicle functions may help the vehicle 140 save processing power, save on energy/power usage, etc.

The vehicle function module 141 may allow the vehicle 140 to perform vehicle functions that were previously not performable by the vehicle (e.g., due to a lack of hardware or software) and/or may allow the vehicle 140 to reduce the resources (e.g., energy, power, processing power, etc.) used by the vehicle 140 when performing vehicle functions. The vehicle function module 141 may also allow the vehicle 140 to perform vehicle functions more quickly, more efficiently, and/or more accurately.

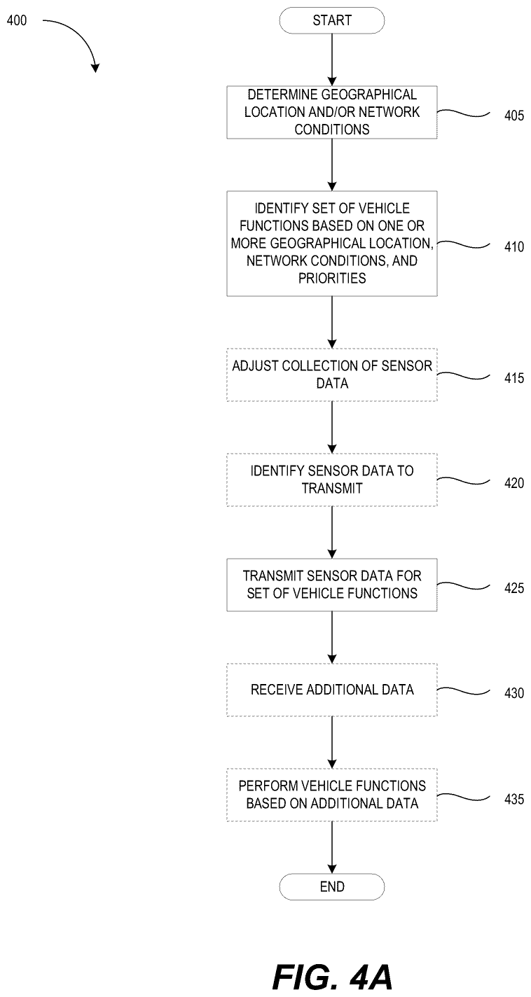

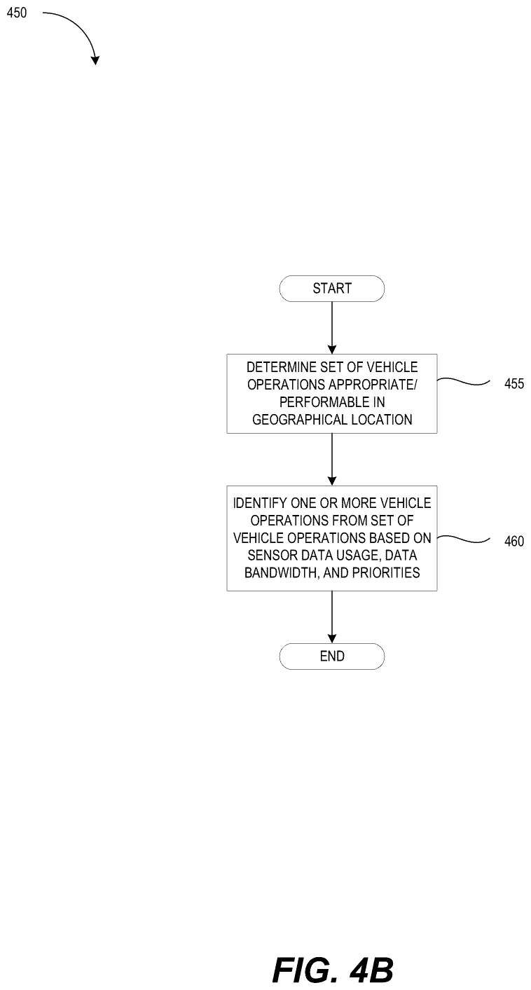

FIG. 4A is a flow diagram of a process 400 for performing vehicle functions, in accordance with one or more embodiments of the present disclosure. Process 400 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the process 400 may be performed by a computing device, a vehicle, a vehicle function module (e.g., vehicle function module 141 illustrated in FIGS. 1, 3, and 7), and/or various components, modules, engines, systems, etc., of a vehicle function module (as illustrated in FIGS. 1, 3, and 7).

With reference to FIG. 4A, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed, and other blocks (which may not be included in FIG. 4A) may be performed between the blocks illustrated in FIG. 4A.

The process 400 begins at block 405 where the process 400 determines the geographical location of the vehicle and/or the network conditions for the vehicle. For example, the process 400 may use GPS data, map data, etc., to determine where the vehicle is located and/or the type of the geographic location. The process 400 may also continuously measure metrics, parameters, etc., that may be used to determine the network conditions for the vehicle. For example, the process 400 may measure the data throughput/bandwidth between the vehicle and an external computing device that may assist the vehicle in performing various vehicle functions.

At block 410, the process 400 may identify a set of vehicle functions based on one or more of the geographical locations (or the type of geographical location), the network conditions (e.g., a data throughput/bandwidth), and priorities associated with the vehicle functions that the vehicle may perform (e.g., each vehicle function that the vehicle may perform may be associated with a priority), as discussed above.

A block 415, the process 400 may optionally adjust collection of sensor data. For example, the process 400 may determine the data bandwidth for communications between the vehicle and the external computing device. Based on the data bandwidth, the process 400 may increase or decrease the amount of sensor data that is collected by one or more sensors. For example, if the data bandwidth is below a threshold, the process 400 may decrease the frame rate or resolution of images/video that is captured by a camera. In another example, if the data bandwidth is over a threshold, the process 400 may increase the frequency at which a LIDAR sensor collects sensor data.

At block 420, the process 400 may optionally identify sensor data to transmit to the external computing device. For example, the vehicle functions (that were identified at block 410) may use sensor data from a set of sensors. The set of sensors may be a subset of all the available sensors in the vehicle. The process 400 may identify the set of sensors (that are used to generate the sensor data that will be used for the identified vehicle functions) and may identify the sensor data generated by the set of sensors.

At block 425, the process 400 may transmit the set of sensor data (for the set of vehicle functions) to the external computing device. For example, the process 400 may use a communication system (e.g., communication system 760 illustrated in FIG. 7) to transmit the sensor data. At block 430, the process 400 may optionally receive additional data from the external computing device. For example, the process 400 may receive instructions for performing the vehicle function (as discussed above). At block 435, the process 400 may optionally perform the vehicle functions based on the additional data. For example, the process 400 may execute the instructions that were received from the external computing device (e.g., may accelerate the vehicle, may turn the vehicle, may increase the cabin temperature, turn on the cabin heater, etc.).

In one embodiment, the process 400 may be periodically or continually repeated (e.g., repeated once every few seconds, few minutes, etc.). This may allow a vehicle to continually identify vehicle applications that are appropriate for a geographical area and are able to be performed based on current network conditions (e.g., based on data bandwidth).

FIG. 4B is a flow diagram of a process 450 for identifying vehicle functions, in accordance with one or more embodiments of the present disclosure. Process 450 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the process 450 may be performed by a computing device, a vehicle, a vehicle function module (e.g., vehicle function module 141 illustrated in FIGS. 1, 3, and 7), and/or various components, modules, engines, systems, etc., of a vehicle function module (as illustrated in FIGS. 1, 3, and 7).

With reference to FIG. 4B, method 450 illustrates example functions used by various embodiments. Although specific function blocks (“blocks”) are disclosed in method 450, such blocks are examples. That is, embodiments are well suited to performing various other blocks or variations of the blocks recited in method 450. It is appreciated that the blocks in method 450 may be performed in an order different than presented, and that not all of the blocks in method 450 may be performed, and other blocks (which may not be included in FIG. 4B) may be performed between the blocks illustrated in FIG. 4B.

The process 450 begins at block 455 where the process 450 determines, identifies, selects, etc., a set of vehicle functions that are appropriate or performable in a geographical location. For example, the process 450 may determine a set of vehicle functions that are appropriate for a parking lot. At block 460, the process 450 may identify one or more of that set of vehicle functions, based on sensor data usage (e.g., an amount of sensor data used by the identified vehicle functions), the current data bandwidth, and optionally priorities for the vehicle functions. For example, the process 450 may identify vehicle functions that have sensor data usage that is less than or equal to the current data bandwidth. In addition, the process 450 may select or identify vehicle functions with higher priority first. For example, the process 450 may prioritize vehicle functions with a higher priority.

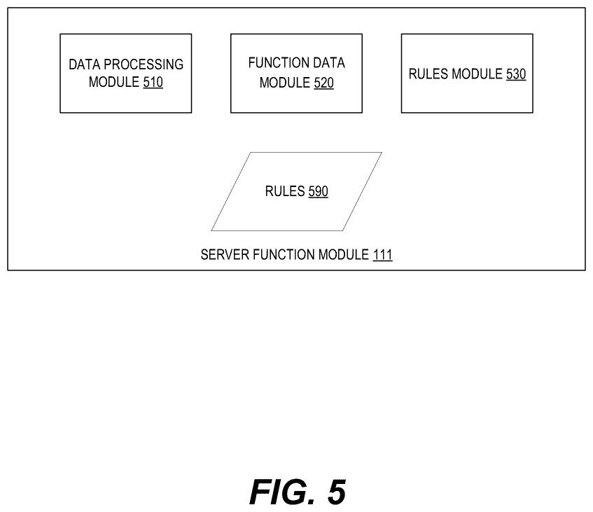

FIG. 5 is a block diagram that illustrates an example server function module 111, in accordance with one or more embodiments of the present disclosure. The server function module 111 includes a data processing module 510, a function data module 520, a rules module 530, and rules 590. Some or all of the modules, components, systems, engines, etc., illustrated in FIG. 5 may be implemented in software, hardware, firmware, or a combination thereof. The server function module 111 may be part of server system (e.g., as illustrated in FIG. 1). As discussed above a vehicle function module (e.g., vehicle function module 141 illustrated in FIG. 1) may operate in conjunction with the server function module 111 to assist a vehicle (e.g., vehicle 140) in performing various vehicle functions.

In one embodiment, the rules 590 may indicate which vehicle functions are performable in which geographical regions and/or types of geographical regions. For example, the rules 390 may include one or more tables, lists, entries, or some other appropriate data structure that associates geographic locations (or types of geographical locations) with vehicle actions that are appropriate/performable in those geographical locations. The rules 590 may also include different sets of rules for different vehicles. For example, different makes and/or models of vehicles may have different vehicle functions that are performable/appropriate for different geographical regions. The rules 590 may also include priorities for the different vehicle functions.

In one embodiment, the data processing module 510 may receive and/or process data that is received from a vehicle (e.g., vehicle 140 illustrated in FIG. 1). For example, the data processing module 510 may receive a set of sensor data from the vehicle. As discussed above, the set of sensor data may have been identified by a vehicle function module (e.g., vehicle function module 141 illustrated in FIG. 1) based on a set of vehicle functions. The set of sensor data may have been identified based on network conditions, a geographical location (or type of geographical location), and one or more priorities associated with the set of vehicle functions, as discussed above. The data processing module 510 may track different sets of sensor data that are received from different vehicles. For example, different vehicles may request assistance with different vehicle functions, which in turn use different sets of sensor data. The data processing module 510 may determine which vehicles requested which vehicle functions and which set of sensor data are associated with the requested vehicle functions for each vehicle.

In one embodiment, the function data module 520 may generate additional data (which may be referred to as function data) based on the sets of sensor data. As discussed above, the additional data may include instructions for performing or carrying out a vehicle function. For example, the additional data may indicate instructions for the vehicle to accelerate and turn a number of degrees toward the right. The additional data may also include results of a vehicle operation. For example, the additional data may identify or indicate objects that were detected in an image/video (e.g., may identify pedestrians, street signs, etc., in an image).

In one embodiment, the function data module 520 may interact or communicate with other components, systems, modules, etc., to generate the additional data. For example, the function data module 520 may use machine learning models to perform calculations, computations, predictions, etc. The function data module 520 may provide the sensor data to the machine learning models and may receive the output (e.g., predictions) generated by the machine learning models. In another example, the function data module 520 may communicate with another computer system may execute an application/service to analyze/process the sensor data.

In one embodiment, the rules module 530 may transmit rules 590 to the vehicles. As discussed above, the rules 590 (which are stored as rules 390 illustrated in FIG. 3) may be used by the vehicles to identify vehicle functions based on one or more of geographical location, network conditions, and priorities for the vehicle functions. The rules module 530 may also transmit update data to the vehicles to update the rules 390 stored in a vehicle, as discussed above. For example, the rules module 530 may receive user input (from an administrator) to change a rule 590, add a rule 590, delete a rule 590, etc.

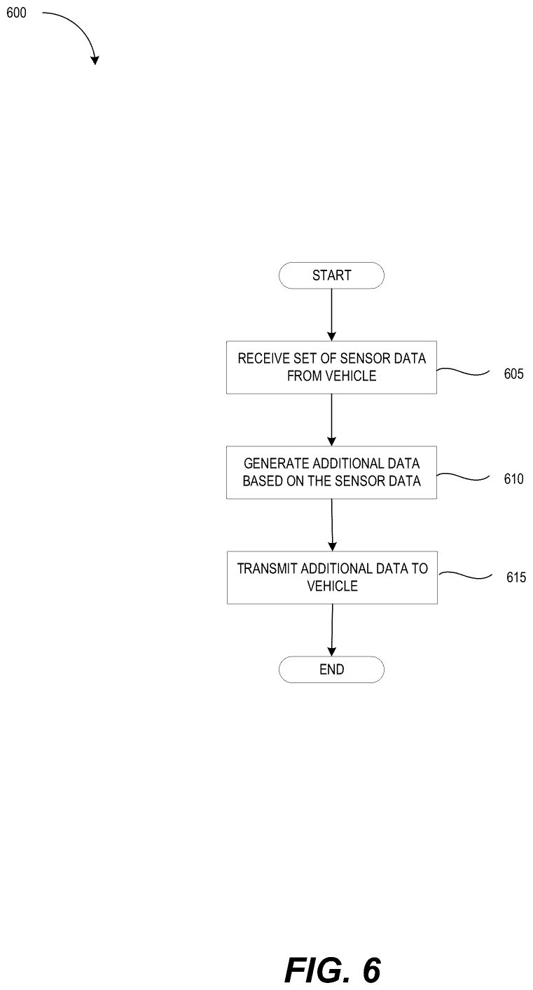

FIG. 6 is a flow diagram of a process 600 for performing vehicle functions, in accordance with one or more embodiments of the present disclosure. Process 600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the process 600 may be performed by a computing device, a server system, a server function module (e.g., vehicle function module 161 illustrated in FIGS. 1 and 5), and/or various components, modules, engines, systems, etc., of a server function module (as illustrated in FIGS. 1 and 5).

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed, and other blocks (which may not be included in FIG. 6) may be performed between the blocks illustrated in FIG. 6.

The process 600 begins at block 605 where the process 600 receives a set of sensor data from a vehicle. The sensor data may be used to perform a set of vehicle functions that are identified by the vehicle based on one or more of a geographical location, network conditions, and priorities for the set of vehicle functions, as discussed above. The process 600 may generate additional data at block 610, based on the sensor data. For example, the process 600 may determine a path for a vehicle using the sensor data and one or more machine learning models. The additional data may include instructions that may be executed by the vehicle to perform a vehicle function (e.g., to drive the vehicle along the determined path). In another example, the process 600 may identify objects in an image using one or more machine learning models. The additional data may be the objects detected in the image (e.g., the results of a vehicle function that detects objects in images). The process 600 may transmit the additional data to the vehicle at block 615.

FIG. 7 is a block diagram that illustrates an example vehicle 140, in accordance with one or more embodiments of the present disclosure. In one embodiment, the vehicle 140 may be an autonomous vehicle (e.g., a self-driving vehicle). For example, the vehicle 140 may be a vehicle (e.g., car, truck, van, mini-van, semi-truck, taxi, drone, etc.) that may be capable of operating autonomously or semi-autonomously. In another embodiment, the vehicle 140 may also be a vehicle with autonomous capabilities. A vehicle with autonomous capabilities may be a vehicle that may be capable of performing some operations, actions, functions, etc., autonomously. For example, vehicle 140 may have adaptive cruise control capabilities and/or lane assist/keep capabilities. A vehicle 140 with autonomous capabilities may be referred to as a semi-autonomous vehicle.

The vehicle 140 may include various systems that allow the vehicle 140 to operate specific functions. For example, vehicle 140 includes a sensor system 730, a control system 740, a communication system 760, an interface system 770, a propulsion system 750, a power source 710, and a battery management system 720. In other embodiments, the vehicle 140 may include more, fewer, and/or different systems, and each system may include more, fewer, and/or different components. Additionally, the systems and/or components may be combined and/or divided in any number/possibility of arrangements.

The sensor system 730 may include one or more sensors (e.g., detectors, sensing elements, sensor devices, etc.). The one or more sensors may provide information about the operation of the vehicle 140, information about the condition of the vehicle 140, information about occupants/users of the vehicle 140, and/or information about the environment (e.g., a geographical area) where the vehicle 140 is located. The one or more sensors may be coupled to various types of communication interfaces (e.g., wired interfaces, wireless interfaces, etc.) to provide sensor data to other systems of the vehicle 140. For example, a sensor may be coupled to a storage device (e.g., a memory, a cache, a buffer, a disk drive, flash memory, etc.) and/or a computing device (e.g., a processor, an ASIC, an FPGA, etc.) via a control area network (CAN) bus (or other type of communication bus, such as a Flexray). In another example, a sensor may be coupled to a storage drive and/or a computing device via Bluetooth, Wi-Fi, etc. Examples of sensors may include, but are not limited to, tire pressure sensors, steering sensors (e.g., to determine the positions/angles of one or more wheels), a compass, temperature sensors, a global positioning system (GPS) receiver/sensor, a light detection and ranging (LIDAR) device/sensor, an ultrasonic device/sensor, a camera (e.g., a video camera), a radar device/sensor, etc.

The control system 740 may include hardware, software, firmware, or a combination thereof that may control the functions, operations, actions, etc., of the vehicle 140. For example, the control system 740 may be able to control a braking system and/or an engine to control the speed and/or acceleration of the vehicle 140. In another example, the control system 740 may be able to control a steering system to turn the vehicle 140 left or right. In a further example, the control system 740 may be able to control the headlights or an all-wheel drive (AWD) system of the vehicle 140 based on weather/driving conditions (e.g., if the environment has snow/rain, if it is nighttime in the environment, etc.). The control system 740 may use sensor data and/or outputs generated by machine learning models to control the vehicle 140.

The control system 740 may use outputs generated one or more machine learning models to control the vehicle. For example, control system 740 may generate one or more steering commands based on the outputs of a machine learning model (e.g., based on objects detected by a machine learning model). The steering command may indicate the direction that a vehicle 140 should be turned (e.g., left, right, etc.) and may indicate the angle of the turn. The control system 740 may actuate one or more mechanisms/systems (e.g., a steering system, a steering wheel, etc.) to turn the vehicle 140 (e.g., to control the vehicle 140) based on the steering command. For example, the control system 740 may actuate one or more steering mechanisms that may turn/move the wheels of the vehicle by a certain number of degrees to steer the vehicle 140. The control system 740 may also control acceleration and/or deceleration of the vehicle 140. For example, the control system 740 may use the accelerator to speed up the vehicle 140 or may use the brake to slow down the vehicle 140.

The communication system 760 may include various devices, systems, components, software, hardware, firmware, etc., that allow the vehicle 140 to communicate (e.g., transmit and/or receive data) with various networks (e.g., computer networks, communication networks, etc.) and/or devices (e.g., other vehicles, server computers, etc.). For example, the communication system 760 may include antennas, network interfaces, wireless network interfaces (e.g., cellular, Wi-Fi, Bluetooth, ZigBee, ZWave, and/or other network interfaces). The communication system 760 may also allow the vehicle 140 to communicate with other vehicles (e.g., V2V communications), with infrastructure (e.g., V2I communications), and/or with other devices/networks (e.g., V2X communications).

The interface system 770 may include various devices, systems, components, software, hardware, firmware, etc., that allow the vehicle 140 to interact with external sensors, other vehicles, external computing devices, and/or a user. For example, the interface system 770 may include buttons, knobs, dials, touch screens, microphones, cameras, and/or other devices that interact with a user, present information to a user, receive user input from a user, etc.

The propulsion system 750 may include various devices, systems, components, software, hardware, firmware, etc., that may be used to move the vehicle 140. For example, the propulsion system 750 may include an engine/motor, an energy source, a transmission, and wheels/tires. The engine/motor may include any combination of an internal combustion engine, an electric motor (that can be powered by an electrical battery, fuel cell, and/or other energy storage device), and/or a steam engine.

The power source 710 may be a source of energy that provides power (e.g., energy, electricity, etc.) to various components, modules, and/or systems of the vehicle 140. For example, the power source 710 may be used to power one or more of the sensor system 730, control system 740, communication system 760, interface system 770, propulsion system 750. Examples of power sources (e.g., energy sources) may include gasoline, diesel, propane, other compressed gas-based fuels, ethanol, solar panels, batteries, and other sources of electrical power. The power source 710 may be a combination of multiple power sources (e.g., may include any combination of fuel tanks, batteries, capacitors, and/or flywheels). In one embodiment, the power source 710 may be a battery (e.g., a lithium-ion battery, an electrical battery, etc.).

The battery management system (BMS) 720 may include various devices, systems, components, software, hardware, firmware, etc., that may the various characteristics of the power source 710. For example, if the power source 710 is a battery, the BMS 720 may monitor characteristics (e.g., operating parameters, conditions, etc.) such as battery temperature, battery voltage, battery current, battery charging and discharging data, etc. The characteristics can be stored locally in the vehicle 140 by the BMS 720. The BMS 720 can also transmit such monitored information via the communications system 760 to other devices (e.g., to a server computer, to a cloud, etc.). The BMS 720 may also regulate the operating conditions of the power source 710. For example, the BMS 720 may cool the battery temperature to within a predefined threshold temperature.

Although not illustrated in FIG. 7, the vehicle 140 may also include various computing resources and/or devices. For example, the vehicle 140 may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The vehicle 140 may also include computing devices. The computing devices may comprise any suitable type of computing device or machine that has a programmable processor including, for example, a computer. In some examples, the computing devices may include a single machine or may include multiple interconnected machines (e.g., multiple computers configured in a cluster).

As discussed above, the vehicle function module 141 may allow an external computing device to assist the vehicle 140 in performing vehicle functions based on one or more of geographical location, network conditions, and priorities for the vehicle functions.

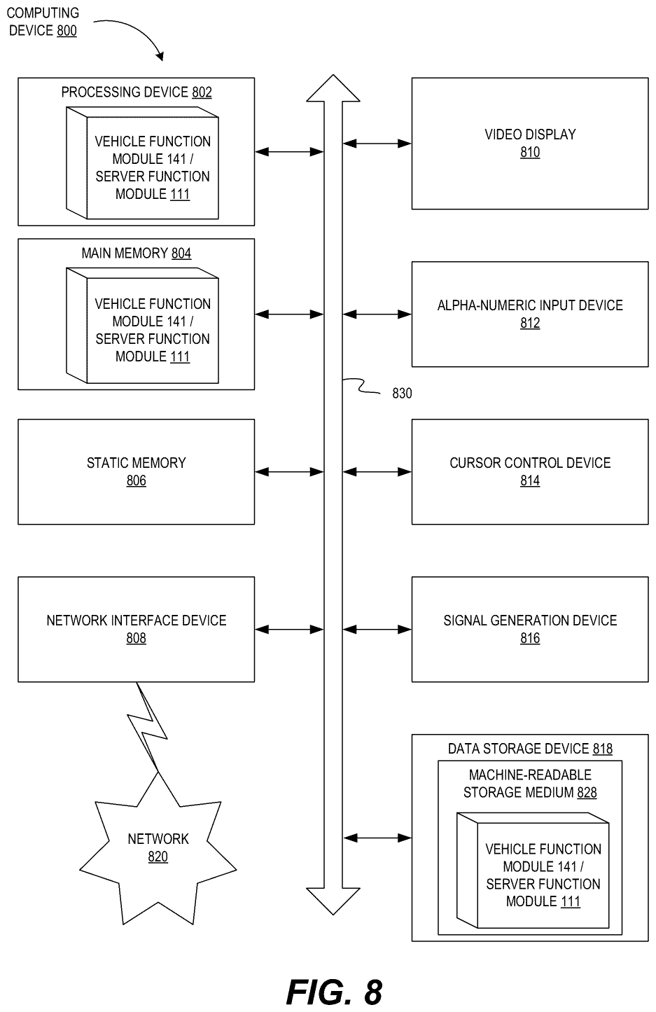

FIG. 8 is a block diagram of an example computing device 800 that may perform one or more of the operations described herein, in accordance with some embodiments. Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device (e.g., a general purpose processor, a PLD, etc.) 802, a main memory 804 (e.g., synchronous dynamic random-access memory (DRAM), read-only memory (ROM)), a static memory 806 (e.g., flash memory and a data storage device 818), which may communicate with each other via a bus 830.

Processing device 802 may be provided by one or more general-purpose processing devices such as a microprocessor, central processing unit, or the like. In an illustrative example, processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also comprise one or more special-purpose processing devices such as an application specific integrated circuit (ASIC), a field programmable gate array (FPGA), a digital signal processor (DSP), network processor, or the like. The processing device 802 may be configured to execute the operations described herein, in accordance with one or more aspects of the present disclosure, for performing the operations and steps discussed herein.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 828 on which may be stored one or more sets of instructions, e.g., instructions for carrying out the operations described herein, in accordance with one or more aspects of the present disclosure. Instructions implementing the different systems described herein (e.g., the vehicle function module 141, server function module 111, and/or various components, modules, engines, systems, etc., of a vehicle function module (as illustrated in FIGS. 1-3) may also reside, completely or at least partially, within main memory 804 and/or within processing device 802 during execution thereof by computing device 800, main memory 804 and processing device 802 also constituting computer-readable media. The instructions may further be transmitted or received over a network 820 via network interface device 808.

While computer-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “determining,” “identifying,” “transmitting,” “receiving,” “updating,” “performing,” “adjusting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
determining one or more of a geographical location of a vehicle and network conditions for the vehicle;
identifying a set of vehicle functions to be assisted by a computing device external to the vehicle based on one or more of the geographical location and the network conditions; and
transmitting a set of sensor data for the set of vehicle functions to the computing device.

2. The method of claim 1, wherein determining network conditions comprises:
determining one or more of latency, throughput, jitter, data loss, noise, and interference for data communicated by the vehicle.

3. The method of claim 1, wherein identifying the set of vehicle functions comprises:
determining an amount of data that can be transmitted to the computing device based on the network conditions; and
identifying the set of vehicle functions based on the amount of data that can be transmitted.

4. The method of claim 1, wherein identifying the set of vehicle functions comprises:
identifying the set of vehicle functions based on the geographical location, wherein the set of vehicle functions are performable in the geographical location.

5. The method of claim 1, wherein the set of vehicle functions are identified further based on a set of priorities associated with the set of vehicle functions.

6. The method of claim 5, wherein identifying the set of vehicle functions comprises:
identifying the set of vehicle functions over other vehicle functions based on the set of priorities.

7. The method of claim 1, wherein the set of vehicle functions are identified further based on a set of rules indicating one or more of geographical locations, network conditions, and priorities associated with a plurality of vehicle functions performable by the vehicle.

8. The method of claim 1, further comprising:
receiving update data indicating updates to one or more rules of a set of rules; and
updating the set of rules based on the update data.

9. The method of claim 1, further comprising:
receiving additional data in response to transmitting the set of sensor data; and
performing the set of vehicle functions based on the additional data.

10. The method of claim 1, further comprising:
adjusting collection of additional sensor data based on one or more of the geographical location and network conditions.

11. An apparatus, comprising:
a memory to store data; and
a processing device operatively coupled to the memory, the processing device to:
determine one or more of a geographical location of a vehicle and network conditions for the vehicle;
identify a set of vehicle functions to be assisted by a computing device external to the vehicle, based on one or more of the geographical location and the network conditions; and
transmit a set of sensor data for the set of vehicle functions to the computing device.

12. The apparatus of claim 11, wherein to identify the set of vehicle functions the processing device is further to:
determine an amount of data that can be transmitted to the computing device based on the network conditions; and
identify the set of vehicle functions based on the amount of data that can be transmitted.

13. The apparatus of claim 11, wherein to identify the set of vehicle functions the processing device is further to:
identify the set of vehicle functions based on the geographical location, wherein the set of vehicle functions are performable in the geographical location.

14. The apparatus of claim 11, wherein the set of vehicle functions are identified further based on a set of priorities associated with the set of vehicle functions.

15. The apparatus of claim 14, wherein to identify the set of vehicle functions the processing device is further to:
identify the set of vehicle functions over other vehicle functions based on the set of priorities.

16. The apparatus of claim 11, wherein the set of vehicle functions are identified further based on a set of rules indicating one or more of geographical locations, network conditions, and priorities associated with a plurality of vehicle functions performable by the vehicle.

17. The apparatus of claim 11, wherein the processing device is further to:
receive additional data in response to transmitting the set of sensor data; and
perform the set of vehicle functions based on the additional data.

18. A method, comprising:
receiving a set of sensor data from a vehicle, wherein the set of sensor data is associated with a set of vehicle functions to be assisted by a computing device external to the vehicle;
generating additional data for the set of vehicle functions based on the set of sensor data, wherein the vehicle performs the set of vehicle functions based on the additional data; and
transmitting the additional data to the vehicle.

19. The method of claim 18, wherein the additional data comprises a set of instructions for performing the set of vehicle functions.

20. The method of claim 18, wherein the set of vehicle functions are identified by the vehicle based on one or more of a geographical location of the vehicle and network conditions for the vehicle.
